(19) United States
(12) Patent Application Publication
(10) Pub. No.: US 2016/0147545 A1
(43) Pub. Date: May 26, 2016

(54) Real-Time Optimization of Many-Core Systems

(71) Applicant: STMicroelectronics International N.V., Schiphol (NL)

(72) Inventors: Abhishek Jain, Delhi (IN); Chittoor Parthasarathy, Grenoble (FR)

(21) Appl. No.: 14/549,332

(22) Filed: Nov. 20, 2014

(51) Int. Cl. G06F 9/445; G06F 11/34; G06F 11/30

(52) U.S. Cl. CPC G06F 9/44505; G06F 11/3024; G06F 11/3466

(57) ABSTRACT

An embodiment is a device including a processor having a plurality of cores, each of the plurality of cores including a real-time monitoring circuit, each of the real-time monitoring circuits configured to determine a status of the respective core and generate status signals based on the determined status in the respective core. The device further comprising a controller configured to: receive the status signals from real-time monitoring circuits of the plurality of cores; and configure an operation of each of the plurality of cores based on their respective status signals.

### TECHNICAL FIELD

The present invention relates generally many-core systems, and, in particular embodiments, to a system and method for real-time optimization of many-core systems.

### BACKGROUND

Many-core processors are becoming more prevalent as the pressures of ever-increasing power consumption and diminishing returns in the performance of uniprocessor architectures have increased. The cores of the many-core processors can be simpler, smaller, and have less power requirements than the typical core in a single or large-core processor.

Although a many-core processor has advantages over a processor with a single core or a few large cores, it also faces many challenges as process technologies scale down. For example, process variations, either static or dynamic, can make transistors unreliable, and reliability over time may deteriorate as transistor degradation becomes more severe as the processor ages. Thus conventional factory testing, as implemented for conventional processors, becomes less effective to ensure reliable computing over time with a many-core processor.

### SUMMARY

An embodiment is a device including a processor having a plurality of cores, each of the plurality of cores including a real-time monitoring circuit, each of the real-time monitoring circuits configured to determine a status of the respective core and generate status signals based on the determined status in the respective core. The device further comprises a controller configured to: receive the status signals from real-time monitoring circuits of the plurality of cores; and configure an operation of each of the plurality of cores based on their respective status signals.

Another embodiment is a many-core processor including a controller configured to continuously monitor status signals from each of the cores of the many-core processor; and if the status signal from one of the cores of the many-core processor indicates the one core is operating outside of a safe operating range, adjust an operating mode of the one core.

A further embodiment is a method for operating a many-core processor, the method including continuously monitoring status signals from each of the cores of the many-core processor, the status signals indicating an operating range of each of the cores; and if the status signal from one of the cores of the many-core processor indicates the one core is in an operating outside of a safe operating range, adjusting an operating mode of the one core.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a many-core process in accordance with an embodiment;

FIG. 2a illustrates a block diagram of a real-time monitor circuit in accordance with an embodiment;

FIG. 2b illustrates a timing diagram illustrating the operation of the real-time monitor circuit in accordance with an embodiment;

FIG. 3 illustrates a block diagram of a method of operation of a many-core processor in accordance with an embodiment;

FIGS. 4a and 4b illustrate scenarios in the operation of a many-core processor in accordance with various embodiments;

FIGS. 5a and 5b illustrate simulation results of a many-core processor in accordance with various embodiments; and

FIG. 6 illustrates simulation results of a many-core processor in accordance with an embodiment.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosed subject matter, and do not limit the scope of the different embodiments.

Embodiments will be described with respect to embodiments in a specific context, namely a many-core processor and a method of operating a many-core processor. Some of the various embodiments described herein include a many-core processor for use in a mobile handset, telecommunications, medical devices, imaging devices, computers, servers, or any system which can utilize a many-core processor. In other embodiments, aspects may also be applied to other applications involving any type of multiple core processor according to any fashion known in the art.

In general terms, using embodiments of the present disclosure, devices can leverage a many-core processor with continuous monitoring of the cores of the many-core processor for errors and faults. In particular, the present disclosure utilizes a real-time monitoring circuit in each of the cores of the many-core processor with the real-time monitoring circuits configured to provide status signals indicating the status of the respective core. These real-time monitoring circuits are designed to predict any actual errors or faults and to provide the appropriate status signals before the actual error or fault occurs. During the execution of actual tasks on the cores, these status signals are continuously monitored by an operation controller. For example, if the operation controller detects a warning status signal in the status signals from cores, the operation controller can adjust the operating mode of those particular cores with the warning status signals to prevent the cores from actually having the error and/or fault which ensures that the processor is always operating within a safe operating range. The adjustment of the operating mode for the cores may be a reduction in operating speed for those cores, a reduction in operating voltage for those cores, removing those cores from the pool of available cores, or a combination thereof. In addition, the operation controller can distribute and schedule the high, normal, and low priority/performance tasks to each of the cores of the processor based on the status signals and/or the operating modes of each of the cores. Thus, the combination of the real-time monitoring circuits and the operation controller allow for the processor to automatically adapt to the dynamic changes in the operating environment for the cores in the processor while also ensuring that the processor is completing the required tasks without errors and/or faults.

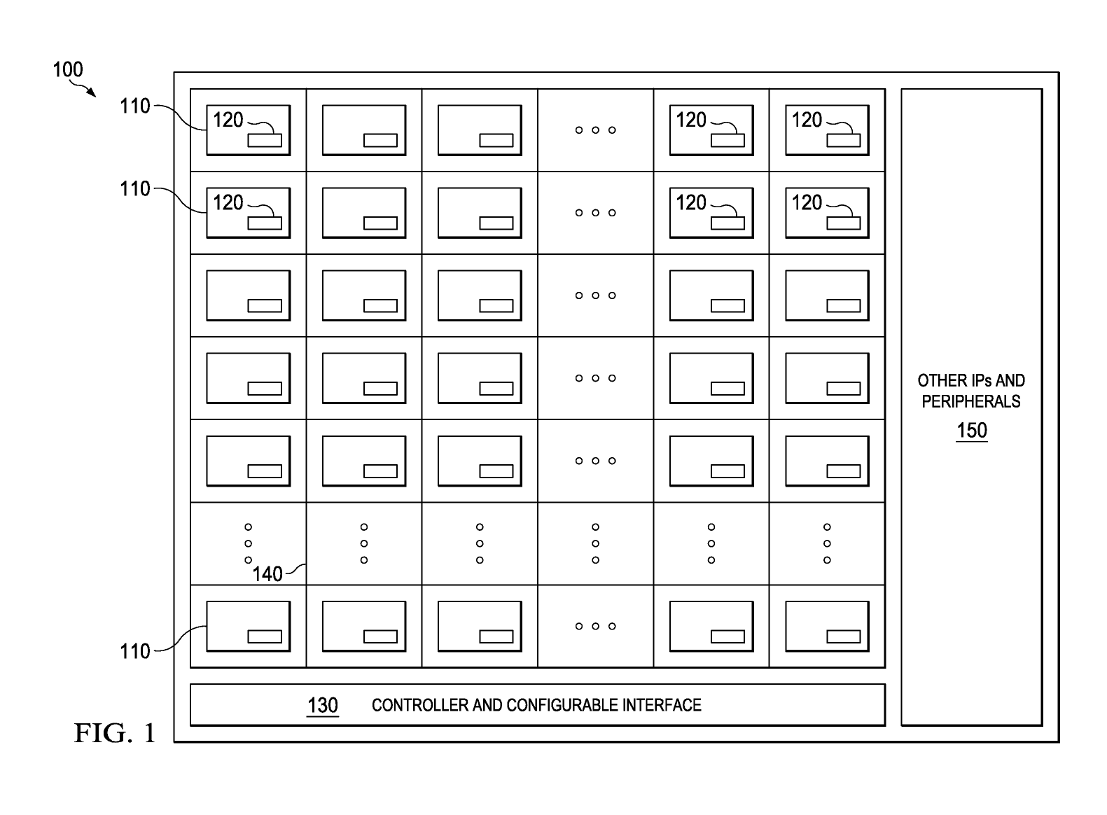

With reference to FIG. 1, there is illustrated a block diagram of a many-core processor 100 in accordance with an embodiment. The many-core processor 100 includes cores 110, real-time monitoring circuits 120, an operation controller 130, an on-chip interconnect 140, and other intellectual properties (IPs) and peripherals 150. Each of the cores 110 may be relatively small cores as compared to typical single-core, dual-core, and quad-core processors. Each of the cores 110 may include a local cache memory (not shown) and also may be coupled to shared memory between the plurality of cores 110 of the processor 100. In an embodiment, each of the cores 110 includes one or more registers, one or more execution units, one or more buffers, one or more memory caches, the like, or a combination thereof. The cores 110 may be arranged in an array of cores 110, such as an 8×8 array, a 10×10 array, or any suitable array of cores 110. It is to be understood that the scope of the present disclosure is not limited to a square array of cores 110, and that many-core processors 100 may include more or fewer cores 110 in other embodiments. The cores 110 may be arranged, for example, in one-dimensional, two-dimensional, or three-dimensional meshes or torus configurations.

Each of the cores 110 further includes a real-time monitoring circuit 120. The real-time monitoring circuits 120 may be configured to provide one or more status signals indicating the status of the respective core 110. These real-time monitoring circuits 120 are designed to predict any actual errors or faults and to provide the appropriate status signals before the actual error or fault occurs. In an embodiment, each of the real-time monitoring circuits 120 include one or more canary flip-flops. The one or more canary flip-flops may be implemented in conjunction with a data flip-flop and may generate a warning that a data flip-flop, and thus, the respective core that includes the data flip-flop is close to failure. Although FIG. 1 only illustrates a single real-time monitoring circuit 120 for each of the cores 110, in some embodiments, there may be more than one real-time monitoring circuit 120 in each of the cores 110. The real-time monitoring circuits 120 will be discussed in further detail below.

The operation controller 130 is coupled to each of the cores 110 in the processor 100. The operation controller 130 is configured to continuously monitor the status signals provided by the real-time monitoring circuits 120 in each of the cores 110. The operation controller 130 may be implemented as a digital circuit or any other suitable implementation of an on-chip controller. The operation controller 130 is coupled to the cores 110 by the on-chip interconnect 140. The operation controller 130 is configured to adjust the operating mode of the cores 110. In an embodiment, each of the cores 110 have a normal-performance operating mode and low-performance operating mode. The adjustment of the operating mode for a core 110 may be a reduction in operating speed for the core 110, a reduction in operating voltage for the core 110, removing the core 110 from the pool of available cores, or a combination thereof. In addition, the operation controller 130 is further configured to distribute and schedule the high, normal, and low priority/performance tasks to each of the cores 110 of the processor based on the status signals and/or the operating modes of each of the cores 110.

For example, based on a warning in the status signals from a particular core 110, the operation controller 130 may reduce the operating speed of the particular core 110 to prevent the particular core 110 from actually failing due to the predicted error and/or fault by the real-time monitoring circuit 120. This error and/or fault prediction and subsequent corrective action ensures that the cores 110 of the processor 100 are always operating within a safe operating range.

The on-chip interconnect 140 couples the cores 110 together such that they may communicate with each other. The on-chip interconnect 140 may be implemented by buses, crossbars, or a network on a chip (NoC) system such as ring, mesh, torus, or the like. In an embodiment, the on-chip interconnect 140 is implemented as a ST Microelectronics' industrial NoC program called Spidergon STNoC. The on-chip interconnect 140 may include switches, routers, data links, the like, or a combination thereof. The on-chip interconnect 140 may also couple the operation controller 130 and/or the other IP's and peripherals 150 to the cores 110. The other IP's and peripherals 150 may include input/output (I/O) interfaces, memory, such as shared memory or global memory, memory controllers, interconnects, logic circuits, the like, a combination thereof, or any suitable component for a processor system.

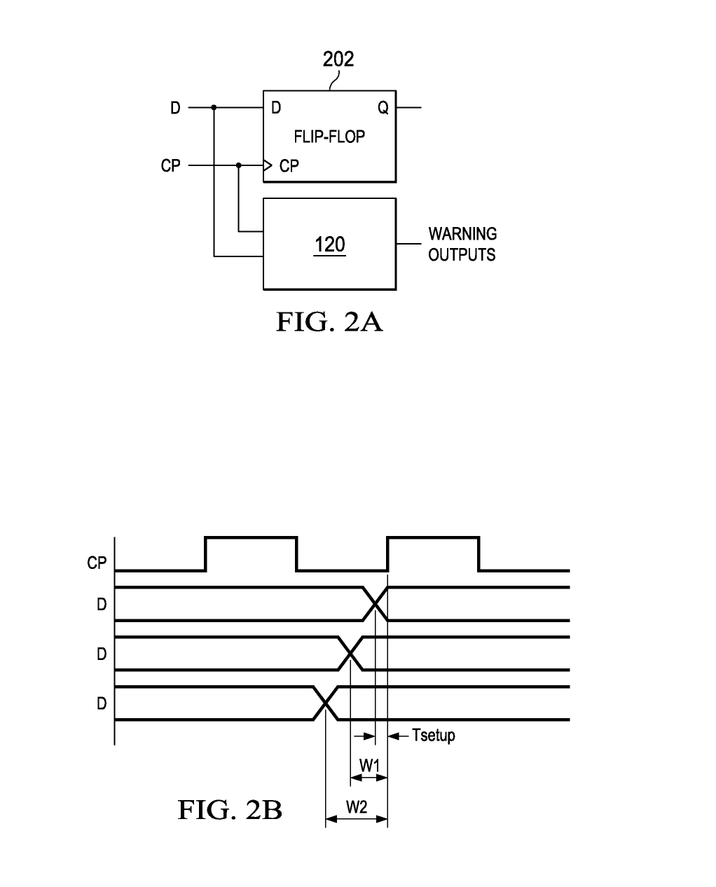

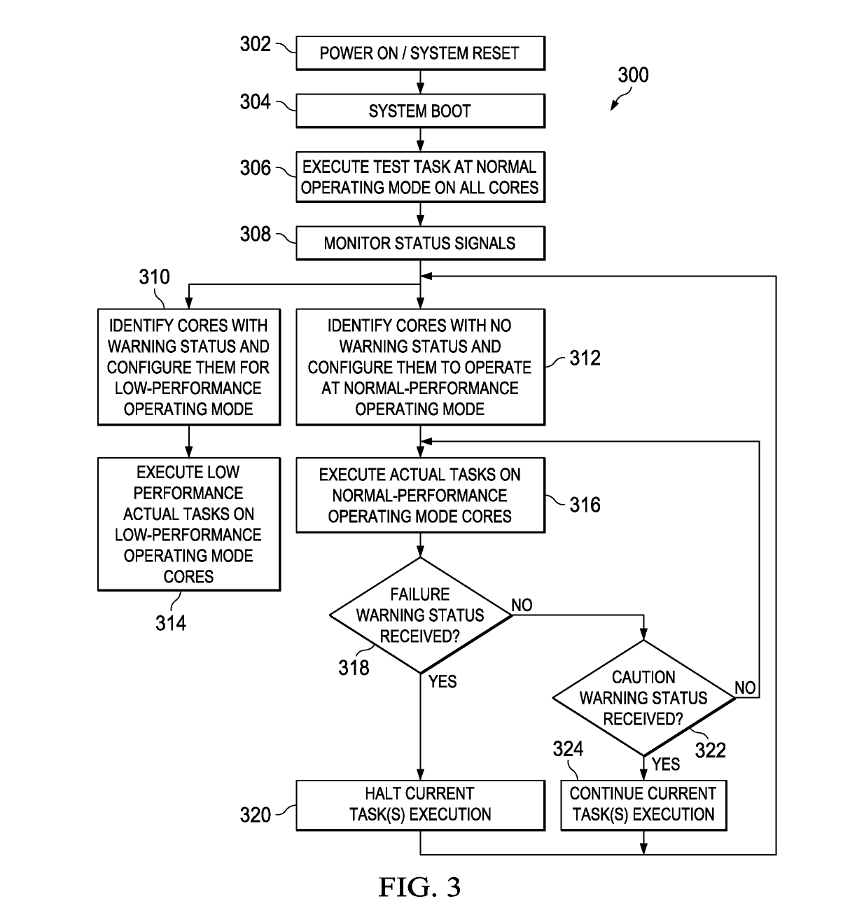

FIG. 2a illustrates a block diagram of a real-time monitor circuit in accordance with an embodiment. FIG. 2a illustrates a data latch 202 and a real-time monitoring circuit 120 in accordance with an embodiment. The data latch 202 may receive a data signal D on a data-signal input and output a data-output signal Q on an output. The data latch 202 may also receive a clock or enable signal CP at a clock or enable input.

In operation, the data latch 202 may output a value on the output signal Q corresponding to a value of the data-input signal D in response to a transition of the clock/enable signal CP. In some embodiments, the transition may be a rising edge, falling edge, or rising and falling edge of the clock/enable signal. The output signal Q may be held at this value until the next operable transition of the clock/enable signal. In this manner, data may propagate through a series of data latches.

The data latch 202 may be single-edge triggered. In some embodiments, the data latch 202 may be a master-slave data-pulse-triggered latch and sample the input data D on a first edge of the clock/enable signal CP and output data on an opposite edge of the clock/enable signal CP.

In order for the value of the data signal D to be output correctly, a transition on the data signal may adhere to set up and hold times of the data latch. For example, a latch may require that a value on the data signal D be held stable for a period of time before and/or after a transition (or operable edge) of the clock/enable signal CP. The area around an operable edge of the clock/enable signal in which a data transition may lead to incorrect operation of the data latch 202 may be an error window. It will be appreciated that this window may be an area of time before the operable edge, after the operable edge, or both before and after the edge.

The real-time monitoring circuit 120 may be provided in order to monitor the likelihood of failure of the data latch 202. The real-time monitoring circuit 120 may monitor, for example, the proximity of a transition of a data signal D to the error window. In this manner, in some embodiments, a minimum error margin may be set for the system. An error margin may be a measure of how close the data latch is to failure. For example, the proximity of a data transition to the error window may be indicative of the margin available.

In some embodiments, the real-time monitoring circuit 120 may include latch circuitry. In an embodiment, the real-time monitoring circuit 120 includes a monitoring circuit and a failure detector circuit. The monitoring circuit (not shown) of the real-time monitoring circuit 120 may receive the data input signal D and provide a second data output signal (not shown). The second data output signal may be provided to the failure detector circuit (not shown). The failure detector circuit may determine whether an error or failure has occurred at the monitoring circuit, and generate status signals at the warning outputs. For example, the failure detector circuit may determine whether the monitoring circuit has clocked out a value of the data signal D incorrectly. The monitoring circuit may be adjusted to be closer to failure than the data latch 202. For example, the data latch 202 and the monitoring circuit may be subject to similar operating conditions. If the system parameters are adjusted to drive the data latch 202 and monitoring circuit closer to failure, then the monitoring circuit will fail before the data latch 202. This may be, for example, because the monitoring circuit may have, for example, a wider error window and/or the data signal to the monitoring circuit may be delayed (the proximity of the data transition to the window may be reduced).

In order to provide monitoring of how close the data latch 202 is to failure, embodiments of the real-time monitoring circuit 120 may make use of cascaded latches (not shown). Each latch in the cascade may be more likely to fail than the previous latch, and a state of the data latches proximity to failure may be determined based on which latches in the cascade have been determined to have failed and which have not. For example, the latches may be cascaded such that an output of a latch provides an input for a successive latch in the cascade. In this manner, a signal may be propagated through the latches. The signal may contain data transitions corresponding to the data transitions on the data-input signal. Each latch may introduce a delay into the propagated signal. For example, each latch may delay a data transition on the propagated signal.

In this manner, a data transition on the propagated signal occurs closer and closer to the time of operation of the cascaded latches. The time of operation may be, for example, a clock edge at which input data is clocked out of a latch. In this manner, each successive latch is more likely to fail than the previous latch.

The first latch of this cascade may be a master latch of data latch 202. The remaining latches in the cascade may form part of the real-time monitoring circuit 120. In some embodiments an error detector may receive the outputs of the cascaded latches and determine whether the latches have clocked data out erroneously. The outputs of the latches may be used to determine, for example, if the data latch 202 is operating with optimum margins, if the data latch 202 can be brought closer to failure, if the data latch 202 is operating too close to failure and the margins should be increased, and/or if the real-time monitoring circuit 120 is operating incorrectly. In some embodiments, the data latch 202 and real-time monitoring circuit 120 may have a test mode in which the real-time monitoring circuit 120 can be tested for correct operation.

The illustrated embodiment of the real-time monitoring circuit 120 is described in further detail including further applicable embodiments in U.S. Patent Application Publication No. 2013/0169331 A1 filed on Jun. 5, 2012 and entitled “Apparatus,” which application is incorporated herein by reference.

FIG. 2b illustrates a timing diagram illustrating the operation of the real-time monitor circuit 120 in accordance with an embodiment. In this embodiment, the timing window Tsetup indicates the minimum amount of setup time of the data input signal D before a transition of the clock/enable signal CP for the data latch 202. FIG. 2b also illustrates two timing windows W1 and W2 starting at different times and both ending at the transition of the clock/enable signal CP. The window W1 is smaller than and within the window W2.

FIG. 2b further illustrates three examples of transitions on the data input signal D, with the first example having a transition at the beginning of window Tsetup, the second example having a transition at the beginning of timing window W1, and the third example having a transition at the beginning of window W2. In some embodiments, the real-time monitoring circuit 120 is configured generate three status signals, a first status signal indicating the respective data latch 202 is in a safe operating range, a second status signal indicating the respective data latch 202 is in a caution operating range, and a third status signal indicating the respective data latch 202 is in a failure operating range. The first status signal may be referred to as the safe status signal, the second status signal may be referred to as the caution status signal, and the third status signal may be referred to as the failure status signal, while the second and third status signals may be collectively referred to as warning status signals as they indicate warnings for the respective data latch 202. These status signals are generated based on the location of the transition of the data input signal D in relation the timing windows W1 and W2. In an embodiment, the real-time monitoring circuit 120 is configured to generate the first status signal (safe operating range) when the transition of the data input signal D is before (to the left in FIG. 2b) both of the windows W2 and W1, generate the second status signal (caution operating range) when the transition of the data input signal D is in the window W2 but not in the window W1, and generate the third status signal (failure operating range) when the transition of the data input signal D is in the window W1. These status signals generated by the real-time monitoring circuit 120 will be provided to the operation controller 130 to indicate the status of the core 110 (see FIG. 1) that includes that particular data latch 202.

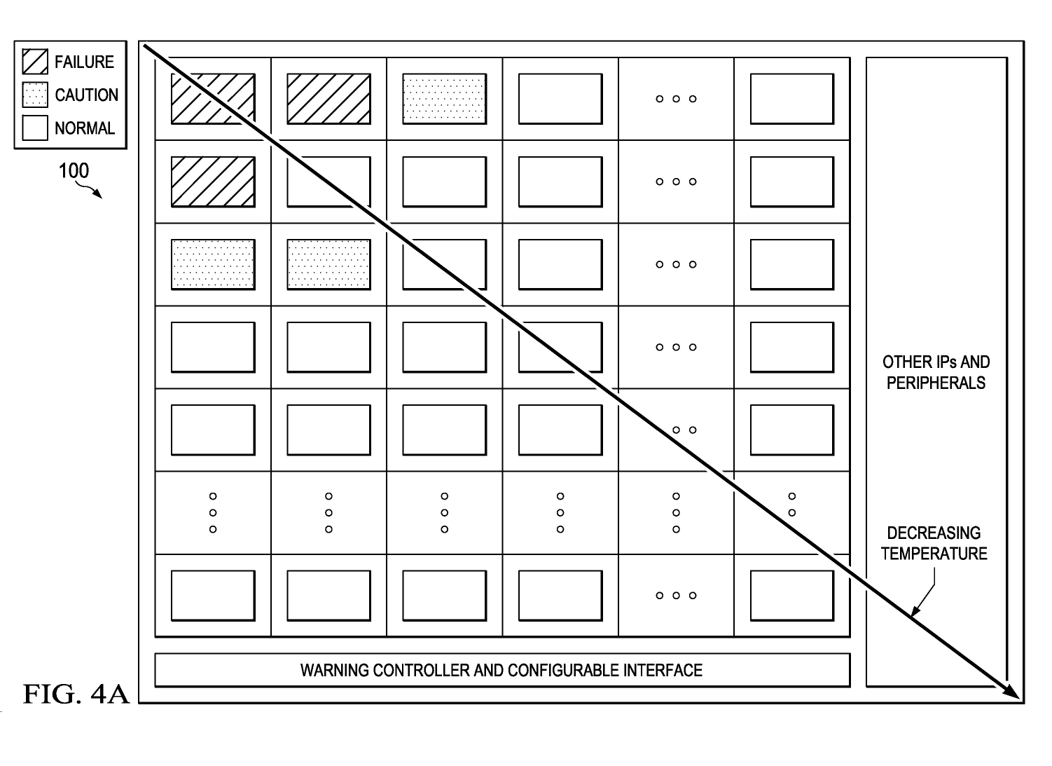

FIG. 3 illustrates a block diagram of a method of operation 300 of the many-core processor 100 including steps 302-324 in accordance with an embodiment. Step 302 includes powering on or resetting the system including the many-core processor 100 or just powering on and resetting the many-core processor 100. Step 304 includes booting up the system and/or the many-core processor 100. The steps 302 and 304 may include many steps and processes such as, for example, verifying processor registers, verifying direct memory access (DMA), verifying physical memory, refreshing memory, initializing cache memory, bus and device initialization, the like, and any other step that is suitable during the powering on and boot up of processor that is known in the art.

Step 306 includes executing one or more test tasks at the normal-performance operating mode on each of the cores 110 in the many-core processor 100. As discussed above, each of the cores 110 includes one or more real-time monitoring circuits 120, and thus, the real-time monitoring circuits 120 also execute the one or more test tasks. Based on the execution of the one or more test tasks, the real-time monitoring circuits 120 generate status signals indicating the real-time operating range (safe, caution, or failure) of the respective core 110.

Step 308 includes monitoring the status signals from the real-time monitoring circuits 120 in each of the cores 110. The status signals may be continuously monitored in real-time by the operation controller 130.

Step 310 includes identifying the cores 110 with warning status signals and configuring these identified cores 110 to operate in a low-performance operating mode. The operation controller 130 may identify the cores with a warning status signal (e.g. the caution status signal and the failure status signal) and configure these cores 110 to operate in a low-performance operating mode to ensure that they do not actually fail due to an error and/or timing fault.

Step 314 includes executing low-performance actual tasks on the low-performance operating mode cores 110 that were identified and configured in step 312. The low-performance actual tasks may be scheduled and assigned to these cores 110 by the operation controller 130. The identified cores 110 may then execute these low-performance actual tasks serially or in parallel depending on the requirements of the particular low-performance actual task and/or the availability of the identified cores 110.

Step 312 includes identifying the cores with no warning status signals and configuring these identified cores 110 to operate in a normal-performance operating mode. The operation controller 130 may identify the cores with no warning status signal (e.g. the cores 110 with the safe status signal) and configure these cores 110 to operate in a normal-performance operating mode.

Step 316 includes executing normal-performance actual tasks on the normal-performance operating mode cores 110 that were identified and configured in step 314. The normal-performance actual tasks may be scheduled and assigned to these cores 110 by the operation controller 130. The identified cores 110 may then execute these normal-performance actual tasks serially or in parallel depending on the requirements of the particular normal-performance actual task and/or the availability of the identified cores 110.

Step 318 includes checking if there was a failure warning status received from any of the normal-performance mode operating mode cores 110 during or after the execution of their normal-performance actual tasks in step 316. The check for the failure warning status (e.g. failure status signal) may be performed by the operation controller 130. This step of checking/monitoring the status signals from the real-time monitoring circuits 120 is performed continuously and in real-time by the operation controller 130.

Step 320 includes halting the current task execution if there was a failure warning status received during step 318. The operation controller 130 may perform the halting of the currently executing task(s). In an embodiment, the operation controller 130 will halt the execution of all tasks on all of the cores 110 in the processor 100. In another embodiment, the operation controller 130 only halt the task(s) executing on the core(s) 110 that generated the failure warning status. After the operation controller 130 halts the currently executing task(s), the core(s) 110 that generated the failure warning are configured for low-performance operating mode (see Step 310) or may be disabled for a period of time.

Step 322 includes checking if there was a caution warning status received from any of the normal-performance mode operating mode cores 110 if there was no failure warning status received during step 318. The check for the caution warning status (e.g. caution status signal) may be performed by the operation controller 130.

Step 324 includes continuing the current task(s) execution if there was a caution warning status received during step 322. After the current task(s) are completed on the core(s) that generated a caution warning status, the operation controller 130 configures those core(s) 110 for low-performance operating mode (see Step 310) or the core(s) 110 be disabled for a period of time.

If there is no caution warning status received during step 322, the core(s) with no failure or caution warning statuses will be assigned new normal-performance actual tasks to execute (see Step 316).

The steps 310-324 are performed repeatedly during the operation of the many-core processor 110 such that the operating modes of the cores 110 are dynamic and respond to the conditions and environment of the cores 110. In addition, the test task(s) from step 306 may be performed periodically on the low-performance mode cores 110 to check if these cores are ready to be placed back in the normal-performance operating mode pool of cores 110.

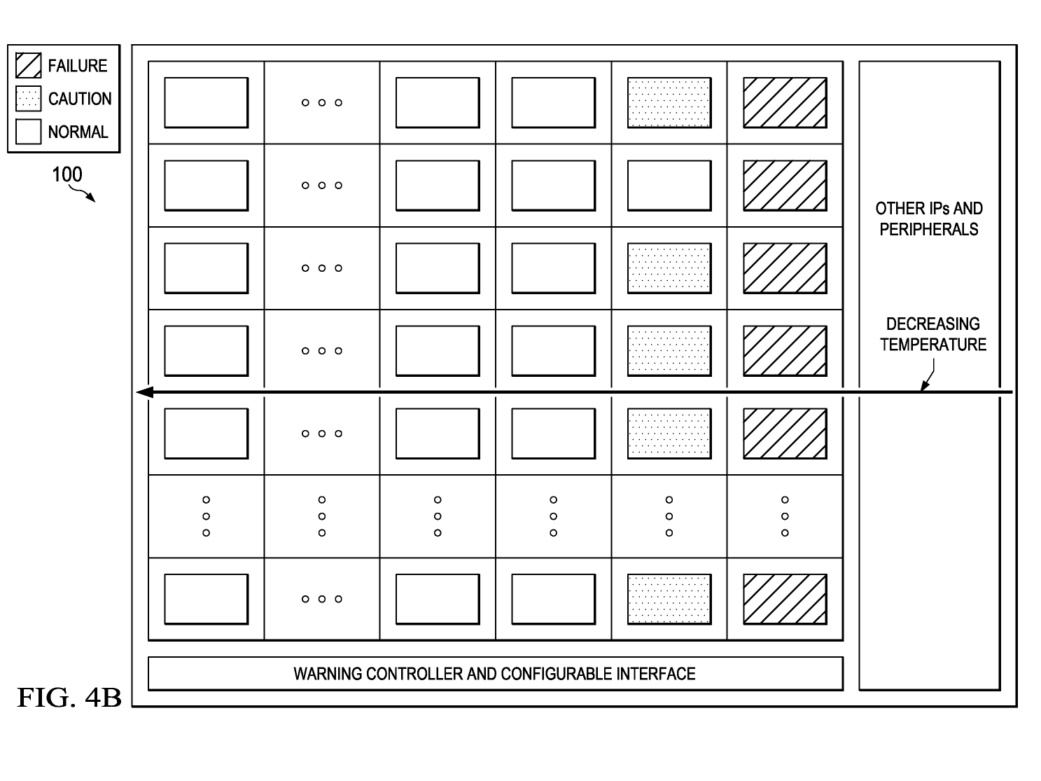

FIGS. 4a and 4b illustrate scenarios in the operation of the many-core processor 100 in accordance with various embodiments. FIG. 4a illustrates an example of the dynamic response of the operating modes of the cores 110 as related to the temperature of the processor 100. As illustrated, the cores 110 in the top left of the processor have generated failure warning statuses and are operating in a low-performance operating mode, with the cores adjacent them in the top left of the processor 100 having generated caution warning statuses and also operating in the low-performance operating mode. The remaining cores 110 having generated the safe status signal and are operating in a normal-performance operating mode. Also illustrated in FIG. 4a is the temperature profile of the processor 100 with the top left portion of the processor 100 having a higher temperature than the rest of the processor 100 and the temperature decreasing from the top left to the bottom right of the processor 100. Hence, in this embodiment, the cores 110 in the higher temperature region of the processor 100 generated the warning statuses and were placed in low-performance mode while the remaining cores operated in normal-performance operating mode.

FIG. 4b illustrates another example of the dynamic response of the operating modes of the cores 110 as related to the temperature of the processor 100. This example is similar to the example in FIG. 4a except that this example has a different temperature profile than FIG. 4a. in this example, the cores 110 along the right edge of the processor 100 have generated failure warning statuses and are operating in a low-performance operating mode, with the cores adjacent them in the right half of the processor 100 having generated caution warning statuses and also operating in the low-performance operating mode. The remaining cores 110 having generated the safe status signal and are operating in a normal-performance operating mode. Also illustrated in FIG. 4b is the temperature profile of the processor 100 with the right portion of the processor 100 having a higher temperature than the rest of the processor 100 and the temperature decreasing from the right to the left of the processor 100. Hence, in this embodiment, the cores 110 in the higher temperature region of the processor 100 generated the warning statuses and were placed in low-performance mode while the remaining cores operated in normal-performance operating mode.

Because the monitoring of the cores 110 is continuous and real-time and because the real-time monitoring circuits 120 predict errors and/or faults, the operating modes of the cores 110 can dynamically change based on the environment (e.g. temperature) and/or other factors to ensure that the cores 110 of the processor 100 always operate at some small margin from actual failure.

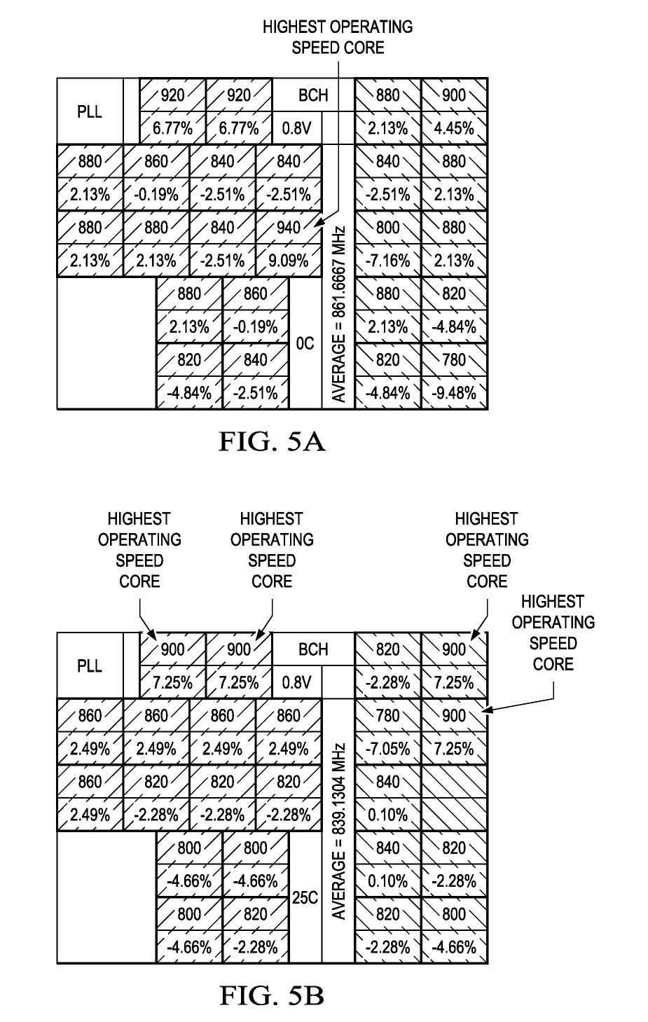

FIGS. 5a and 5b illustrate simulation results of the operation of a many-core processor in accordance with various embodiments. FIG. 5a illustrates the simulation results of the operation of the many-core processor at 0° C. and FIG. 5b illustrates the simulation results of the operation of the many-core processor at 25° C. Both of these Figures illustrate the average operating speed of the cores in their respective simulations, 861.6667 MHz for FIG. 5a and 839.1304 MHz for FIG. 5b. In addition, each of the FIGS. 5a and 5b illustrate the operating speed for each of the cores and the respective percentage above or below the average speed for each core.

As illustrated in FIG. 5a, the core operating at the highest speed at 0° C. is operating at 940 MHz, which is 9.09% above the average speed. In FIG. 5b, the cores operating at the highest speed at 25° C. are operating at 900 MHz, which is 7.25% above the average speed. As illustrated in the Figures, the highest operating speed cores change as the temperatures of the processors change. This may be due to the process variation, aging profile differences between the various cores, or various other dynamic factors. These simulations illustrate the importance of the continuous real-time monitoring of the cores of the present disclosure as the “best” cores can dynamically change depending of many different factors that cannot be accounted for with only burn-in tests at the factory or even periodic testing (e.g. once a day or only at startup) during the life of the processor.

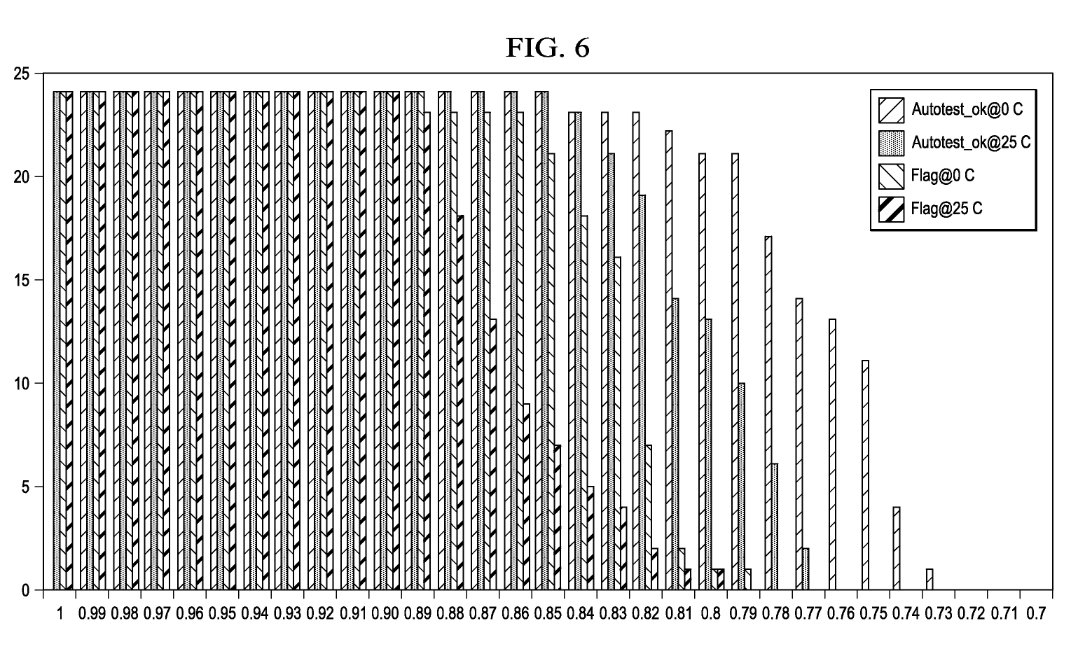

FIG. 6 illustrates experimental results of a many-core processor in accordance with an embodiment. These results illustrate the status of the cores of a 24 core many-core processor as the supply voltage of the processor is decreased from 1 Volt (V) at 0.01 V increments. The experiment was conducted at 0° C. and 25° C.

Each supply voltage value has for different bars in the graph, the first bar (from the left) indicates the number of cores that passed a test at 0° C., the second bar indicates the number of cores that passed the test at 25° C., the third bar indicates the number of cores that do not have warning statuses at 0° C., and the fourth bar indicates the number of cores that do not have warning statuses at 25° C. For example, at a supply voltage of about 0.82 V, 23 cores passed the test at 0° C., 19 cores passed the test at 25° C., 7 cores do not have a warning status at 0° C., and 2 cores do not have a warning status at 25° C. Hence, the various cores of the processor respond differently to the different supply voltages and temperatures. Thus, the continuous monitoring of the cores allows the processor to automatically adapt to the dynamic changes in the operating environment of the cores while also ensuring that the processor is completing the required tasks without errors and/or faults.

According to various embodiments, devices can leverage a many-core processor that has continuous monitoring of the cores of the many-core processor for errors and faults. The real-time monitoring circuits are designed to predict any actual errors or faults and to provide the appropriate status signals before the actual error or fault occurs, and an operation controller continuously monitors these status signals. If the operation controller detects a warning status signal in the status signals from cores, the operation controller can adjust the operating mode of those particular cores with the warning status signals to prevent the cored from actually having the error and/or fault which ensures that the processor is always operating within a safe operating range. In addition, the operation controller can distribute and schedule the high, normal, and low priority/performance tasks to each of the cores of the processor based on the status signals and/or the operating modes of each of the cores. Thus, the combination of the real-time monitoring circuits and the operation controller allow for the processor to automatically adapt to the dynamic changes in the operating environment for the cores in the processor while also ensuring that the processor is completing the required tasks without errors and/or faults.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A device comprising:
a processor comprising a plurality of cores, each of the plurality of cores comprising a real-time monitoring circuit, each of the real-time monitoring circuits configured to determine a status of the respective core and generate status signals based on the determined status in the respective core; and
a controller configured to:
receive the status signals from real-time monitoring circuits of the plurality of cores; and
configure an operation of each of the plurality of cores based on their respective status signals.

2. The device of claim 1, wherein the configuring the operation of each of the plurality of cores comprises adjusting an operating speed of at least one of the plurality of cores.

3. The device of claim 1, wherein the configuring the operation of each of the plurality of cores comprises generating a pool of available cores from the plurality of cores based on the status signals from the real-time monitoring circuits; and removing at least one of the plurality of cores from the pool of available cores.

4. The device of claim 3, wherein the configuring the operation of each of the plurality of cores further comprises assigning a low performance task to the at least one removed core.

5. The device of claim 3, wherein the generating the pool of available cores from the plurality of cores based on the status signals from the real-time monitoring circuits comprises:
assigning a test task to each of the plurality of cores;
executing the test task on each of the plurality of cores;
receiving the status signals from the real-time monitoring circuits of the plurality of cores based on the execution of the test task; and
generating the pool of available cores from the cores in the plurality of cores based on the status signals from the execution of the test task.

6. The device of claim 5, wherein the step of assigning the test task to each of the plurality of cores is performed during a boot up sequence of the device.

7. The device of claim 1, wherein the configuring the operation of each of the plurality of cores further comprises halting execution of each of the plurality of cores.

8. The device of claim 1, wherein the processor is a many-core processor and comprises more than ten cores.

9. The device of claim 1, wherein each of the real-time monitoring circuits comprises a canary flip-flop.

10. The device of claim 1, wherein each of the real-time monitoring circuits is further configured to generate three status signals, a first status signal indicating the respective core is in a safe operating range, a second status signal indicating the respective core is in a caution operating range, and a third status signal indication the respective core is in a failure operating range.

11. The device of claim 1, wherein each of the real-time monitoring circuits is further configured to continuously monitor the status of the respective core during execution of test tasks and actual tasks.

12. A many-core processor comprising:
a controller configured to:
continuously monitor status signals from each of the cores of the many-core processor; and
if the status signal from one of the cores of the many-core processor indicates the one core is operating outside of a safe operating range, adjust an operating mode of the one core.

13. The many-core processor of claim 12, wherein the adjusting the operating mode of the one core comprises adjusting an operating speed of the one core.

14. The device of claim 12, wherein the controller is further configured to generate a pool of available cores from the cores of the many-core processor based on the status signals from the cores; and removing at least one of the cores from the pool of available cores based on the status signal indicating the at least one core is operating outside of the safe operating range.

15. The many-core processor of claim 14, wherein the controller is further configured to assign a low performance task to the at least one removed core.

16. The many-core processor of claim 14, wherein the generating the pool of available cores from the cores of the many-core processor based on the status signals from the cores comprises:
assigning a test task to each of the cores;
executing the test task on each of the cores;
receiving the status signals from the cores based on the execution of the test task; and
generating the pool of available cores based on the status signals from the execution of the test task.

17. The many-core processor of claim 12 further comprising:
a real-time monitoring circuit in each of the cores of the many-core processor, each of the real-time monitoring circuits configured to determine the status of respective core and to generate the status signals based on the determined status in the respective core.

18. The many-core processor of claim 17, wherein each of the real-time monitoring circuits comprises a canary flip-flop.

19. The many-core processor of claim 12, wherein the adjusting the operating mode of the one core further comprises halting execution of the one core.

20. A method for operating a many-core processor, the method comprising:
continuously monitoring status signals from each of the cores of the many-core processor, the status signals indicating an operating range of each of the cores; and
if the status signal from one of the cores of the many-core processor indicates the one core is in an operating outside of a safe operating range, adjusting an operating mode of the one core.

21. The method of claim 20, wherein the step of continuously monitoring status signals from each of the cores of the many-core processor is performed during execution of test tasks and actual tasks.

22. The method of claim 20, wherein the status signals from each of the cores of the many-core processor indicates three operating ranges, the three operating ranges comprising a safe operating range, a caution operating range, and a failure operating range.

23. The method of claim 20 further comprising:
generating a pool of available cores from the cores of the many-core processor based on the status signals from the cores; and
removing at least one of the cores from the pool of available cores based on the status signal indicating the at least one core is operating outside of the safe operating range.

24. The method of claim 23, wherein the generating the pool of available cores from the cores of the many-core processor based on the status signals from the cores further comprises:
assigning a test task to each of the cores of the many-core processor;
executing the test task on each of the cores of the many-core processor;
generating the status signals at the cores based on the execution of the test task; and
generating the pool of available cores by an operation controller based on the status signals from the execution of the test task.
